(19) United States
(12) Patent Application Publication
(10) Pub. No.: US 2004/0215548 A1
(43) Pub. Date: Oct. 28, 2004

(54) Method, system and program product for receiving bids for multiple auctions and presenting real-time auction results

(75) Inventors: Trieu C. Chieu, Scarsdale, NY (US); Aaron A. Guse, Burnsville, MN (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/420,499

(22) Filed: Apr. 22, 2003

(51) Int. Cl. G06F 17/60

(52) U.S. Cl. 705/37

(57) ABSTRACT

Under the present invention, a user can enter bids for multiple electronic auctions simultaneously (e.g., from a single web page). Specifically, a user can select multiple auctions from a group of auctions. Once selected, the auctions will be presented to the user on a gallery web page. Using the gallery web page, the user can then enter bids for any of the selected auctions. After being entered, the bids will be submitted to the corresponding auctions. Thereafter, real-time results of the auctions will be presented to the user on a result web page.

### FIELD OF THE INVENTION

The present invention generally relates to a method, system and program product for receiving bids for multiple auctions and presenting real-time auction results.

### BACKGROUND OF THE INVENTION

As the use of the Internet becomes more prevalent, web users are increasingly being provided with better on-line capabilities. For example, today a web user can order goods/services, obtain information and advertise their business on-line. In addition, the growth of the Internet has lead to an increased popularity of on-line auction sites (e.g., EBAY.COM). In general, on-line auction sites allow individuals and businesses to submit items for auction. Web users can view the items, and submit bids for those items he/she desires. Since all interaction is electronic, the on-line auctions are not limited by geography or any other factors that traditionally limit in-person auctions.

Typically, an electronic auction provides a fixed window of time for web users to submit a bid on an item. Once a bid is submitted, a web user must then await the outcome of the auction. This window of time is often a period of great uncertainty for the web user because he/she does not know whether their bid is “winning.” To help address this period of uncertainty, some systems have implemented a “bidding by proxy” feature that allows web users to designate an initial bid and a maximum bid. For example, assume that web user “A” submits an initial bid of $5.00 and a maximum bid of $20.00 for a compact disk. Further assume that subsequently, web user “B” submits a bid of $10.00 for the same compact disk. In this scenario, the auction site will automatically raise web user “A's” bid over $10.00 (e.g., to $11.00).

Unfortunately, the existing auction systems have many drawbacks. One particular area of shortfall is in results notification. Specifically, in many systems, upon submitting a bid the web user is not informed of the results until the window of time for the auction has expired. Even if proxy bidding is in place, the web user still does not know the status of his/her bids. Moreover, any results that are presented are not presented in real-time. Thus, the status of bids as displayed may not be accurate. Accordingly, the results displayed do not indicate where the web user is currently ranked with respect to other web users bidding in the same auction.

In view of the foregoing, there exists a need for a method, system and program product for receiving bids for multiple auctions and presenting real-time auction results. Specifically, a need exists for a web user to be able to select multiple auctions from a group of auctions. A further need exists for the selected auctions to be displayed on a web page that includes fields for entering bids therefor. Still yet, a need exists for bids to be received for multiple auctions, and submitted to the corresponding auctions. In addition, a need exists for the current results of the corresponding auctions to be presented in real-time.

### SUMMARY OF THE INVENTION

In general, the present invention provides a method, system and program product for receiving bids for multiple auctions and presenting real-time auction results. Specifically, under the present invention, a web user can select multiple auctions from a group of auctions. The selected auctions will then be presented to the web user in a “gallery” web page that includes fields for submitting bids therefor. The web user can then enter bids for two or more of the selected auctions. After submission of the bids, the real-time results of the corresponding auctions will be presented to the web user.

According to one embodiment of the present invention, a method for receiving bids for a plurality of auctions and presenting real-time results is provided. The method comprises: accepting a plurality of selections of auctions from a user; presenting a gallery web page listing the plurality of selections to the user, wherein the gallery web page includes a respective field for entering a bid for each of the plurality of selections; receiving the gallery web page including an entered bid for at least two of the plurality of selections from the user; submitting the entered bids; and presenting real-time results of the at least two of the plurality of selections to the user.

According to another embodiment of the present invention, a computer-implemented method for bidding in a plurality of auctions and receiving real-time results is provided. The computer-implemented method comprises: selecting a plurality of auctions in a group of auctions; receiving a gallery web page displaying the plurality of auctions, wherein the gallery web page includes fields for entering bids for the plurality of auctions; entering and submitting a bid for at least two of the plurality of auctions; and receiving real-time results of the at least two of the plurality of auctions on a result web page.

According to another embodiment of the present invention, a system for bidding in a plurality of auctions and presenting real-time results is provided. The system comprises: a bidding system for selecting a plurality of auctions from a group of auctions, and for presenting the plurality of auctions on a gallery web page, wherein each of the plurality of auctions has an associated set of fields on the gallery web page for entering bid information; and a result system for receiving the gallery web page containing bid information for at least two of the plurality of auctions, and for presenting real-time results of the at least two of the plurality of auctions on a result web page

According to yet another embodiment of the present invention, a program product stored on a recordable medium for bidding in a plurality of auctions and presenting real-time results is provided. When executed, the program product comprises: program code for selecting a plurality of auctions from a group of auctions, and for presenting the plurality of auctions on a gallery web page, wherein each of the plurality of auctions has an associated set of fields on the gallery web page for entering bid information; and program code for receiving the gallery web page containing bid information for at least two of the plurality of auctions, and for presenting real-time results of the at least two of the plurality of auctions on a result web page.

Therefore, the present invention provides a method, system and program product for receiving bids for multiple auctions and presenting real-time results.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for (simultaneously) bidding in multiple auctions and presenting real-time results, according to one embodiment of the present invention.

FIG. 2 depicts gallery web page presenting a plurality of selected auctions and associated bids, according to one embodiment of the present invention.

FIG. 3 depicts a confirmation web page confirming the selected auctions and associated bids, according to one embodiment of the present invention.

FIG. 4 depicts a result web page depicting real-time results of the selected auctions, according to one embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### BEST MODE FOR CARRYING OUT THE INVENTION

As indicated above, the present invention provides a method, system and program product for receiving bids for multiple auctions and presenting real-time auction results. Specifically, under the present invention, a web user can select multiple auctions from a group of auctions. The selected auctions will then be presented to the web user in a “gallery” web page that includes fields for submitting bids therefor. The web user can then enter bids for two or more of the selected auctions. After submission of the bids, the real-time results of the corresponding auctions will be presented to the web user.

It should be understood in advance that under the present invention, the term “auction” typically refers to an electronic auction that occurs over a network such as the Internet. Moreover, in a typical embodiment the present invention is implemented in conjunction with an “English” auction (although this need not be the case). It should also be understood that each auction could involve one or more “items” (e.g., goods and/or services). For example, an auction for a video game system could include a game console, two controllers and two games. Whether this is considered to be one item (i.e., the video game system) or five items (i.e., the sum of the individual pieces of the video game system) is not intended to be a limiting part of the present invention.

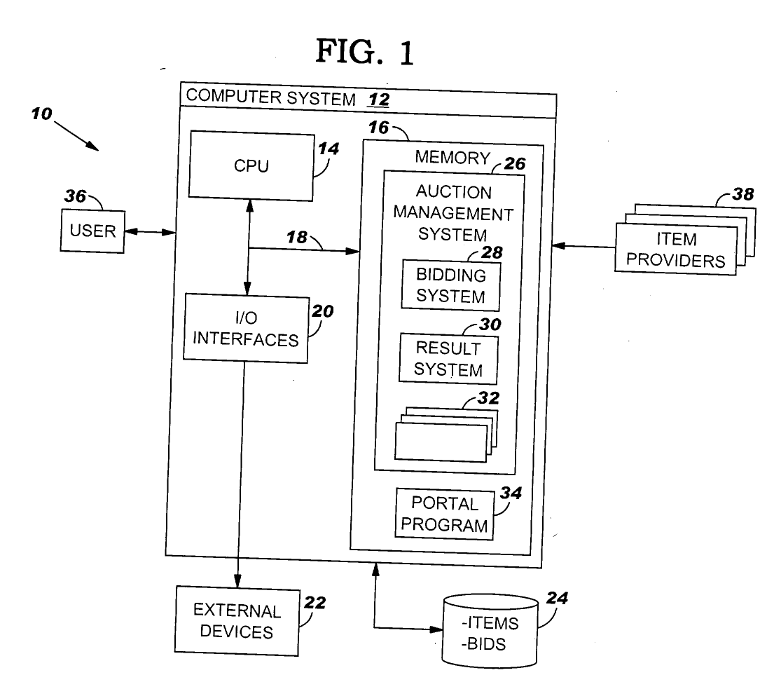

Referring now to FIG. 1, system 10 for (simultaneously) bidding in multiple auctions and presenting real-time results is shown. As depicted, system 10 includes computer system 12 that manages auctions under the present invention. To this extent, computer system 12 typically receives information on items up for auction from item providers 38, and bid information on the items from web user 36 (hereinafter “user 36”). Communication between computer system 12, user 36 and item providers 38 can occur in any known manner. For example, communication could occur via a direct hardwired connection (e.g., serial port), or via an addressable connection in a client-server (or server-server) environment that may utilize any combination of wireline and/or wireless transmission methods. In the case of the latter, the server and client may be connected via the Internet, a wide area network (WAN), a local area network (LAN), a virtual private network (VPN) or other private network. The server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

In general, computer system includes central processing unit (CPU) 14, memory 16, bus 18, input/output (I/O) interfaces 20, external devices/resources 22 and storage unit 24. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, similar to CPU 14, memory 16 may reside at a single physical location, comprising one or more types of data storage, or be distributed across a plurality of physical systems in various forms.

I/O interfaces 20 may comprise any system for exchanging information to/from an external source. External devices/resources 22 may comprise any known type of external device, including speakers, a CRT, LED screen, hand-held device, keyboard, mouse, voice recognition system, speech output system, printer, monitor/display, facsimile, pager, etc. Bus 18 provides a communication link between each of the components in computer system 12 and likewise may comprise any known type of transmission link, including electrical, optical, wireless, etc.

Storage unit 24 can be any system (e.g., a database) capable of providing storage for information under the present invention such as items up for auction, submitted bids, etc. As such, storage unit 24 could include one or more storage devices, such as a magnetic disk drive or an optical disk drive. In another embodiment, storage unit 24 includes data distributed across, for example, a local area network (LAN), wide area network (WAN) or a storage area network (SAN) (not shown). Storage unit 24 may also be configured in such a way that one of ordinary skill in the art may interpret it to include one or more storage devices.

It should be understood that although not shown, additional components, such as cache memory, communication systems, system software, etc., may be incorporated into computer system 12. It should be understood that although not shown, user 36 and item providers 38 could each operate a computer system (e.g., workstation, laptop, hand-held device, etc.) having computerized components (e.g., CPU, memory, etc.) similar to computer system 12.

Stored in memory 16 of computer system 12 is auction management system 26 and (optional) portal program 34. The presence of portal program 34 in memory 26 indicates that computer system 12 can be a “portal server” that delivers web content to web users such as user 36 (although this need not be the case). For example, portal program 34 Could be WebSphere Portal Server, which is commercially available from International Business Machines of Armonk, N.Y. To this extent, computer system 12 typically manages and delivers an auction website to web users. As depicted, auction management system 26 includes bidding system 28, result system 30 and other assorted systems 32 (e.g., an authentication system). In general, when user 36 wishes to access the auction website to participate in auctions, user 36 may first be authenticated via an authentication system (e.g., system 32). Such authentication is optional and can be done in any known fashion (e.g., user name and password). As such, authentication is not intended to be a limiting part of the present invention.

In any event, bidding system 28 provides the necessary webpages/interfaces for user 36 to select a plurality of auctions from a group of auctions. For example, if the auction website managed by computer system 12 lists one hundred active auctions, user 36 could participate in any number (e.g., ten) of the active auctions. The selection of the auctions can be accomplished in any fashion. For example, user 36 could be presented with a web page having a list of active actions. Each active auction could have a corresponding selection mechanism (e.g., button, link, check box or the like). User 36 can then select the selection mechanism for each active auction in the list in which he/she wishes to participate.

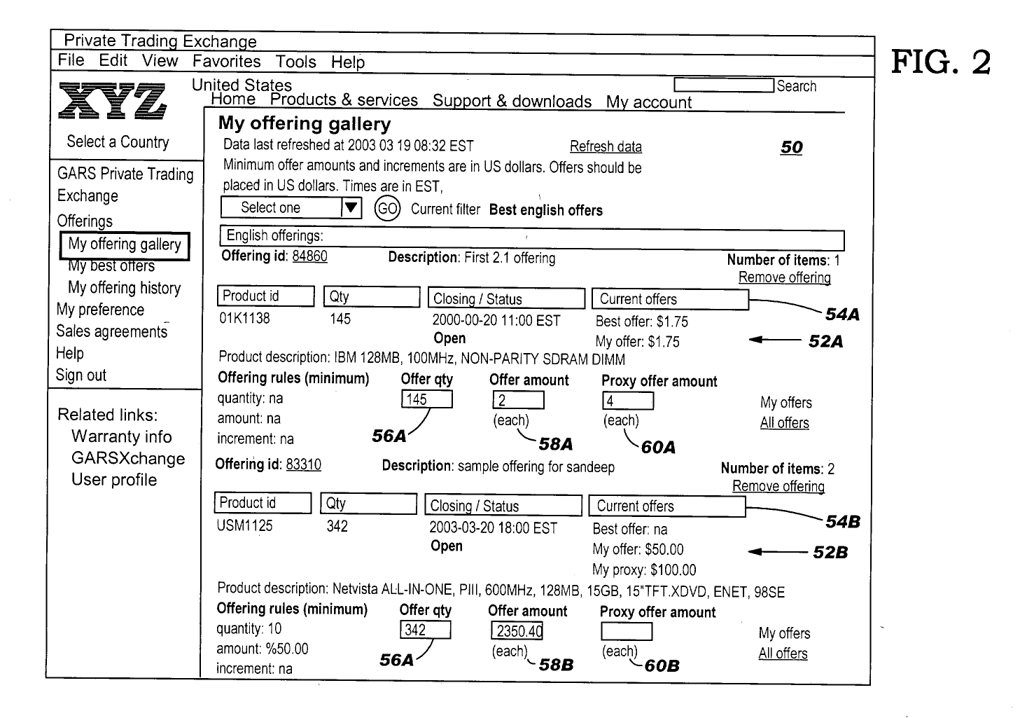

Once user 36 has selected the desired auctions, the selected auctions will be presented to user 36 in a “gallery” web page. Referring to FIG. 2, an exemplary gallery web page 50 is shown. As depicted, gallery web page 50 presents auctions 52A-B selected by user 36. With each auction 52A-B, user 36 is also presented with auction information 54A-B. Such information can include the product/item identification, an available item quantity, an auction closing date/time, and current offers. Each auction 52A-B is also presented with an associated/respective set of fields for entering bid information. Specifically, quantity fields 56A-B allow user 36 to enter desired quantities for each auction, offer amount fields 58A-B allow user 36 to enter an initial bid (amount) for each auction, and proxy fields 60A-B allows user 36 to enter a maximum bid (amount) for each auction. For example, auction 52A pertains to product no. 01K1138. As denoted in fields 56A, 58A and 60A, user 36 has indicated that he wishes to purchase all 145 available units with an initial bid of $2.00 each and a maximum bid of $4.00 each. Entering a maximum bid provides proxy-bidding capabilities, as described above. It should be understood that user 36 does not have to submit bids for each auction he/she initially selected. For example, user 36 can select five auctions, but submit bids for only two if he/she so desires. In any event, as can be seen, gallery web page 50 provides user 36 with the capability to enter bids (i.e., simultaneously bid) on multiple selected auctions substantially contemporaneously.

It should be understood that the capability to simultaneously select and participate in multiple auctions could incorporate any of the teachings of U.S. Patent Application Publication No. US 2002/0082946A1, assigned to the same Assignee as the instant application and herein incorporated by reference.

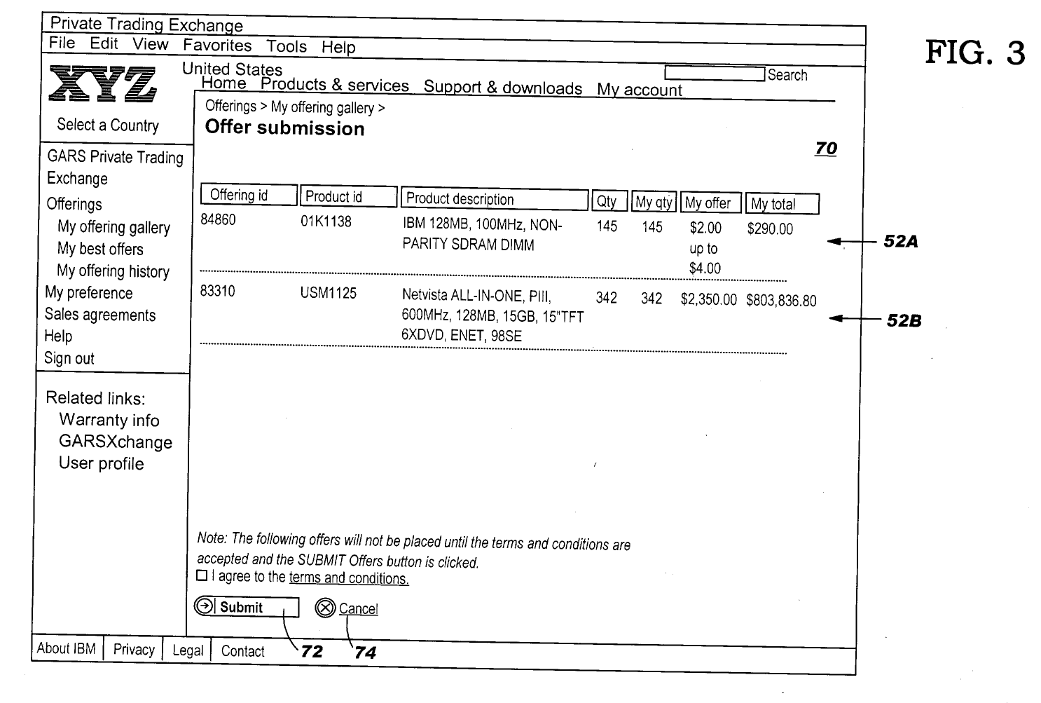

Referring now to FIG. 3, a confirmation web page 70 is shown. Confirmation web page 70 may include all of the bid information entered by user 36 in gallery web page 50 of FIG. 2. As can be seen, user 36 submitted bid information for both selected auctions 52A-B. Confirmation web page 70 provides user 36 with an opportunity to confirm and/or change bid information. Upon selection of submission button 72, the bid information will be sent to the corresponding auctions. Alternatively, upon selection of cancel button 74, the information will not be submitted.

Referring back to FIG. 1, after submission of bid information, result system 30 will tabulate and present (e.g., display) the real-time results. Specifically, the bid information entered by user 36 will be submitted to the corresponding auctions (as managed by computer system 12). To this extent, each auction could be managed/maintained within storage unit 24 with the auction and bid information arranged into a table or the like. For example, in addition to auction information, the table for each auction can include the identification of each bidding web user, their initial bid entered, their maximum bid entered, and their current bid. At the outset, the current bid for each web user will be his/her initial bid. However, result system 30 can adjust the current bids up to the maximum entered bid by proxy. For example, in auction 52A of FIG. 2, user 36 submitted an initial bid of $2.00 and a maximum bid of $4.00. If another web user tops the initial bid of $2.00, result system 30 can increase the “current bid” entry for user 36 in the table up to $4.00. As additional bids are received, result system 30 can continue to update the tables associated with the corresponding auctions.

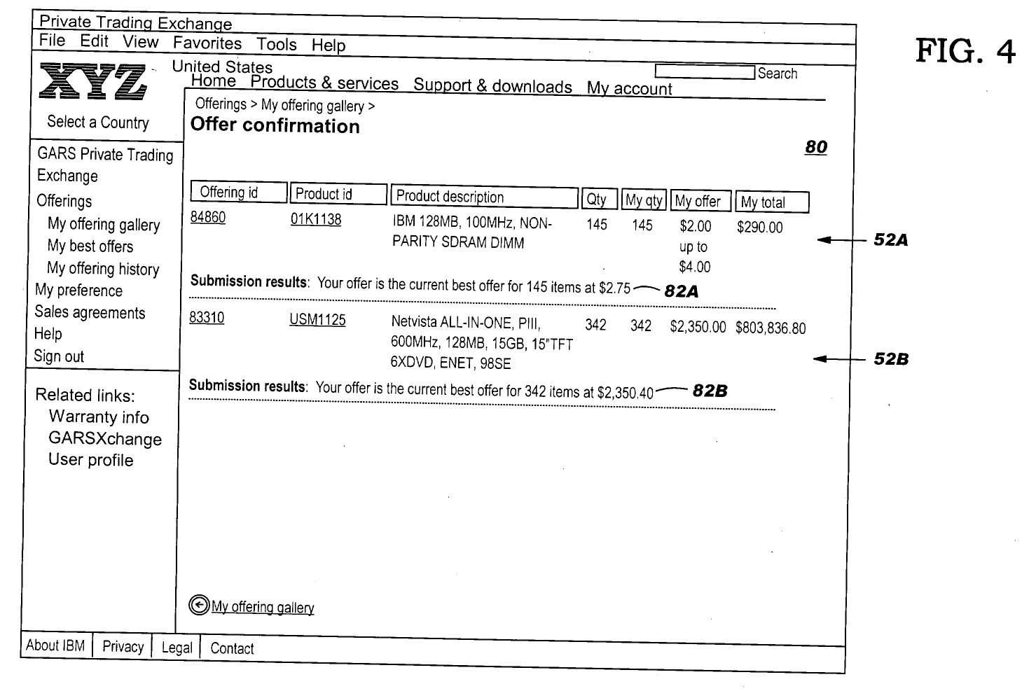

Under the present invention, result system 30 will also present real-time results to user 36 (and any other web users submitting bids). Specifically, upon receiving the bid information from user 36, result system 30 will (immediately) generate and display a result page (to user 36) that has current, real-time results of the auctions in which user 36 submitted a bid. Referring to FIG. 4, result web page 80 is shown. As depicted, and similar to confirmation web page 70, result web page 80 may include all of the information pertaining to the auctions 52A-B in which user 36 submitted bid information. However, result web page 80 further includes real-time result information 82A-B for each auction 52A-B. For example, for auction 52A-B user 36's bid is currently the best bid for 145 units at $2.75 per unit. Thus, the real-time results provide a current bid ranking so that user 36 knows exactly where he/she stands with respect to other bidders at that instant in time. If user 36 was not in first place, user 36 may consider increasing his/her bid. As indicated above, it is important to have real-time results so that user 36 knows whether he/she needs to increase a bid. Having real-time results may improve a bidder's success in an auction. In addition, although not shown, the real-time results can also indicate additional result information such as an auction status (e.g., how much time is left to place a bid). After being displayed, result web page 80 could be periodically updated as the real-time result information changes.

It should be understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

We claim:

1. A method for receiving bids in a plurality of auctions and presenting real-time results, comprising:
accepting a plurality of selections of auctions from a user;
presenting a gallery web page listing the plurality of selections to the user, wherein the gallery web page includes a respective field for entering a bid for each of the plurality of selections;
receiving the gallery web page including an entered bid for at least two of the plurality of selections from the user;
submitting the entered bids; and
presenting real-time results of the at least two of the plurality of selections to the user.

2. The method of claim 1, wherein the plurality of auctions are electronic and are implemented over a network.

3. The method of claim 2, wherein the network is the Internet.

4. The method of claim 1, wherein the real-time results incorporate the entered bids received with the gallery web page.

5. The method of claim 1, wherein the real-time results are presented to the user on a result web page.

6. The method of claim 1, wherein the real-time results indicate a bid ranking of the entered bids.

7. The method of claim 1, further comprising authenticating the user prior to accepting the plurality of selections.

8. A computer-implemented method for bidding in a plurality of auctions and receiving real-time results, comprising:
selecting a plurality of auctions in a group of auctions;
receiving a gallery web page displaying the plurality of auctions, wherein the gallery web page includes fields for entering bids for the plurality of auctions;
entering and submitting a bid for at least two of the plurality of auctions; and
receiving real-time results of the at least two of the plurality of auctions on a result web page.

9. The method of claim 8, wherein the plurality of auctions are electronic auctions and are implemented over a network.

10. The method of claim 9, wherein the network is the Internet.

11. The method of claim 8, wherein the real-time results incorporate the entered bids.

12. The method of claim 8, wherein the real-time results indicate a bid ranking of the bids.

13. The method of claim 8, further comprising authenticating a user prior to the selecting step.

14. A system for bidding in a plurality of auctions and presenting real-time results, comprising:
a bidding system for selecting a plurality of auctions from a group of auctions, and for presenting the plurality of auctions on a gallery web page, wherein each of the plurality of auctions has an associated set of fields on the gallery web page for entering bid information; and
a result system for receiving the gallery web page containing bid information for at least two of the plurality of auctions, and for presenting real-time results of the at least two of the plurality of auctions on a result web page.

15. The system of claim 14, wherein the plurality of auctions are electronic auctions and are implemented over a network.

16. The system of claim 15, wherein the network is the Internet.

17. The system of claim 14, further comprising an authentication system for authenticating a user of the system.

18. The system of claim 14, wherein the real-time results incorporate the bid information received with the gallery web page.

19. The system of claim 14, wherein the real-time results indicate a bid ranking of the bid information.

20. The system of claim 14, wherein each set of fields on the gallery web page includes:
a quantity field for entering a item quantity;
an offer amount field for entering an initial bid; and
a proxy field for entering a maximum bid.

21. A program product stored on a recordable medium for bidding in a plurality of auctions and presenting real-time results, which when executed, comprises:
program code for selecting a plurality of auctions from a group of auctions, and for presenting the plurality of auctions on a gallery web page, wherein each of the plurality of auctions has an associated set of fields on the gallery web page for entering bid information; and
program code for receiving the gallery web page containing bid information for at least two of the plurality of auctions, and for presenting real-time results of the at least two of the plurality of auctions on a result web page.

22. The program product of claim 21, wherein the plurality of auctions are electronic auctions and are implemented over a network.

23. The program product of claim 22, wherein the network is the Internet.

24. The program product of claim 21, further comprising program code for authenticating a user of the system.

25. The program product of claim 21, wherein the real-time results incorporate the bid information received with the gallery web page.

26. The program product of claim 21, wherein the real-time results indicate a bid ranking of the bid information.

27. The program product of claim 21, wherein each set of fields on the gallery web page includes:
a quantity field for entering a item quantity;
an offer amount field for entering an initial bid; and
a proxy field for entering a maximum bid.
